(19) United States
(12) Patent Application Publication
(10) Pub. No.: US 2010/0033416 A1
(43) Pub. Date: Feb. 11, 2010

(54) ROW-MODULATION GRAY-LEVEL LCD DEVICE AND METHOD THEREOF

(75) Inventors: Shyh-Yueh Wang, Taichung (TW); Chuen-Tzay Jean, Taichung City (TW); Chia-Hui Chen, Taichung County (TW); Chiu-Yuan Huang, Taichung City (TW); Yen-Liang Chen, Taichung County (TW); Wei-Jen Tang, Taichung City (TW); Chien-Chih Hsu, Changhua County (TW)

Correspondence Address: Muncy, Geissler, Olds & Lowe, PLLC, P.O. BOX 1364, FAIRFAX, VA, 22038-1364, US

(73) Assignee: POWERTIP TECHNOLOGY CORP.

(21) Appl. No.: 12/189,372

(22) Filed: Aug. 11, 2008

(51) Int. Cl. G09G 3/36

(52) U.S. Cl. 345/98

(57) ABSTRACT

A row (common electrode)-modulation gray-level LCD device and a method thereof, which use a row-modulation device to input at least two sequentially generated original common voltage signals to the common electrode of the same row, whereby the sequentially generated original common voltage signals cooperate with the segment voltage signals to generate voltage differences in the common electrode and turn on or turn off the same monochromatic pixel in a time-division mode. The accumulated effect of the time-division turn-on and turn-off states enables the same monochromatic pixel to present gray-pixel.

### FIELD OF THE INVENTION

The present invention relates to an LCD device and a method thereof, particularly to an LCD device and a method thereof, whereby a single-level drive monochromatic LCD panel can have gray levels.

### BACKGROUND OF THE INVENTION

Refer to FIG. 1, a diagram schematically showing the electrodes of an LCD panel. Electrodes X1-Xn and Electrodes Y1-Yn are arranged crosswise to form a matrix, and each intersection point is a pixel on the panel. A pixel lightens or darkens according to the voltage difference applied thereon. The gray level which is shown from the LCD device is usually realized with a FRM (Frame Rate Modulation) or PWM (Pulse Width Modulation) technology.

In the FRM technology, the gray level is determined by the ratio of turn-on cycles and turn-off cycles per second. Thus, the display time of each pixel has to increase, and light has to accumulate to a sufficient amount during the interval of vision persistence. Besides, the frequency of lightening a pixel and the frequency of the background light should not overlap lest the gray-level effect be affected.

In the PWM technology, the gray level is determined by the turn-on interval in each segment. Therefore, the original LCD drive circuit has to be replaced to adjust the output timing. In other words, the output control of the segment circuit needs a special design, which increases the complexity and cost of the circuit.

### SUMMARY OF THE INVENTION

Accordingly, the present invention discloses a row-modulation gray-level LCD device and a method thereof to enable a single-level LCD drive chip and panel to have gray levels and solve the conventional problem.

The primary objective of the present invention is to provide a row-modulation gray-level LCD device and a method thereof, wherein at least two original common voltage signals and the segment voltage signals cooperate to sequentially drive the monochromatic pixels of the same row in a time-division mode, whereby the time-division turn-on and turn-off states of the monochromatic pixels enable a single-level LCD drive chip to present gray levels.

The device of the present invention comprises a monochromatic LCD panel, a single-level driver and a row-modulation device. The monochromatic LCD panel has a plurality of common electrodes and a plurality of segment electrodes; the common electrodes and the segment electrodes intersect vertically and are respectively arranged on an upper layer and a lower layer. The single-level driver sequentially generates a plurality of original common voltage signals and a plurality of segment voltage signals according to the timing. The row-modulation device has a plurality of input junctions and a plurality of output junctions. The input junctions are arranged into at least two sets, and each of the sets is electrically coupled to one of the output junctions.

The single-level driver is electrically coupled to a plurality of segment electrodes via a plurality of segment circuits and electrically coupled to the input junctions of the row-modulation device via a plurality of common circuits. The output junctions of the row-modulation device are electrically coupled to the common electrodes via a plurality of common-set circuits.

The single-level driver sequentially generates a plurality of original common voltage signals. At least two original common voltage signals input to the common electrodes in a time-division mode to generate a new common voltage signal. The voltage differences of the new common voltage signal and at least two segment voltage signals turn on or turn off the monochromatic pixel in a time-division mode. The effects of turn-on and turn-off states are accumulated by vision persistence to form gray levels.

### BRIEF DESCRIPTION OF THE DRAWINGS

FIG. 1 is a diagram schematically showing the electrodes of a common passive LCD panel;

FIG. 2 is a diagram schematically showing the electrodes of a monochromatic LCD panel according to one embodiment of the present invention;

FIG. 3 is a diagram schematically showing a gray-level LCD device according to one embodiment of the present invention;

FIG. 4 is a diagram showing waveforms of original common voltage signals according to one embodiment of the present invention;

FIG. 5 is a diagram schematically showing the function of a row-modulation device according to one embodiment of the present invention; and

FIG. 6 is a diagram showing waveforms of new common voltage signals according to one embodiment of the present invention.

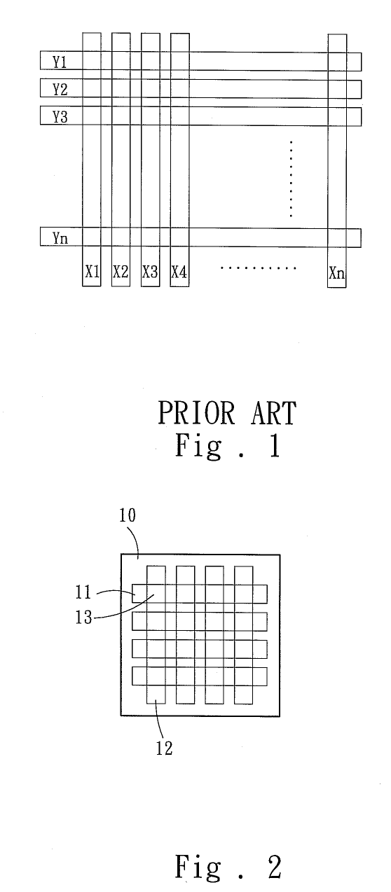

### DETAILED DESCRIPTION OF THE PREFERRED EMBODIMENTS

Below, the technical contents of the present invention are described in detail in cooperation with the drawings.

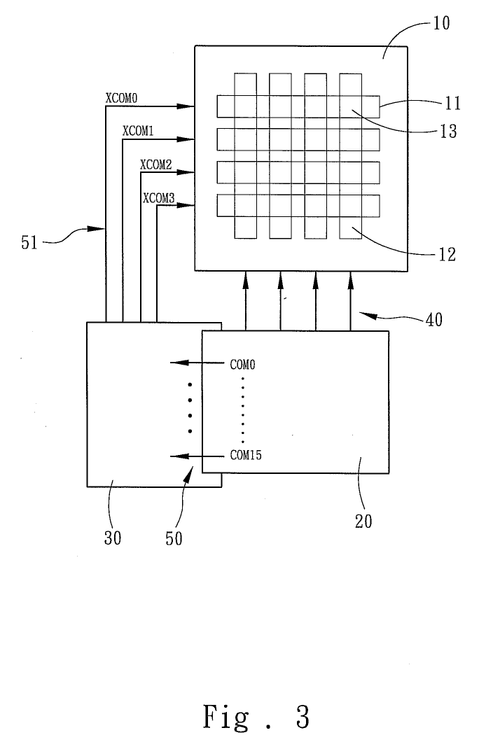

Refer to FIG. 2 and FIG. 3. The system of the present invention comprises a monochromatic LCD panel 10, a single-level driver 20 and a row-modulation device 30. The monochromatic LCD panel 10 has a plurality of common electrodes 11 and a plurality of segment electrodes 12; the common electrodes 11 and the segment electrodes 12 intersect vertically and are respectively arranged on an upper layer and a lower layer. Thus, the monochromatic LCD panel 10 has a plurality of monochromatic pixels 13 corresponding to the intersections of the common electrodes 11 and the segment electrodes 12. The monochromatic LCD panel 10 shown in the drawings is a LCD panel having a resolution of 4×4, but the present invention is not limited thereto.

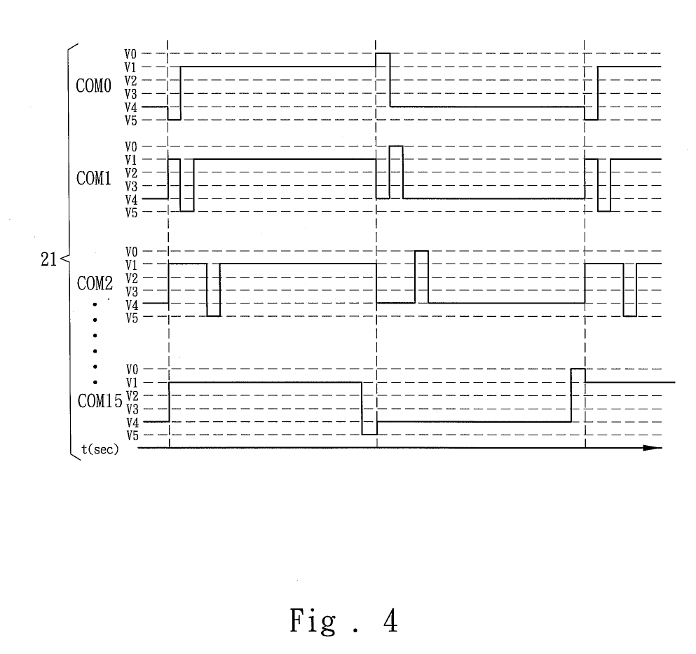

Refer to FIG. 4 also. The single-level driver 20 sequentially generates a plurality of original common voltage signals 21 and a plurality of segment voltage signals (not shown in the drawings) according to the timing. In the embodiment shown in FIG. 4, a plurality of original common voltage signals 21 (COM0-COM15) has a duty cycle of 1/16. The monochromatic pixels 13 are driven by the voltage differences between a plurality of segment voltage signals and a plurality of original common voltage signals 21.

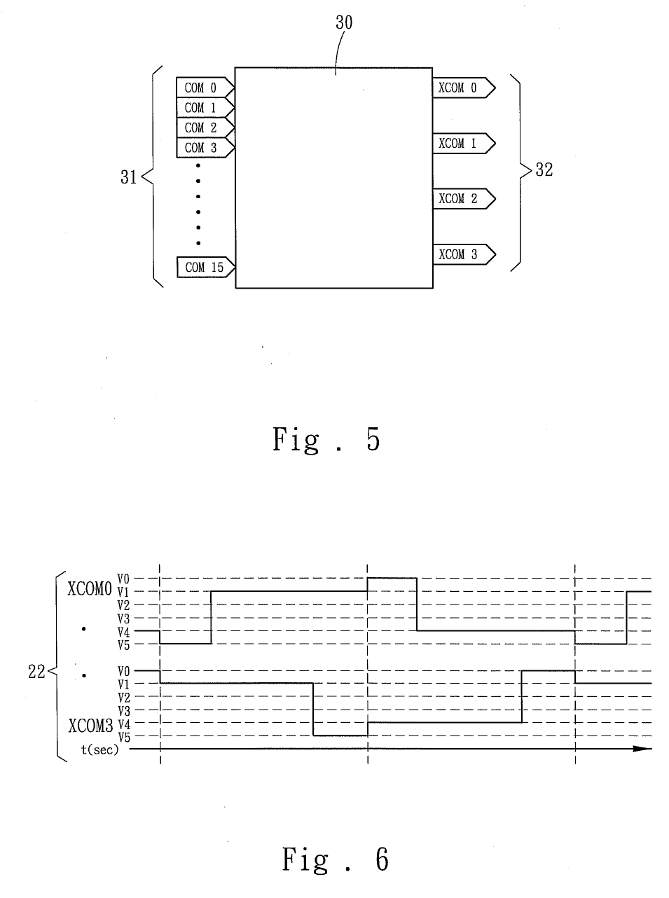

Refer to FIG. 5. The row-modulation device 30 has a plurality of input junctions 31 and a plurality of output junctions 32. The input junctions 31 are arranged into at least two sets, and each of the sets is electrically coupled to one of the output junctions 32. In the embodiment shown in FIG. 5, there are 16 input junctions 31 arranged into four sets and 4 output junctions 32, and each of the four sets is coupled to one of the output junctions 32.

Refer to FIG. 3 again. In the present invention, the single-level driver 20 is electrically coupled to a plurality of segment electrodes 12 via a plurality of segment circuits 40; the single-level driver 20 is electrically coupled to a plurality of input junctions 31 of the row-modulation device 30 via a plurality of common circuits 50; a plurality of output junctions 32 of the row-modulation device 30 are electrically coupled to a plurality of common electrodes 11 via a plurality of common-set circuits 51.

Below is described the driving method generating gray levels according to the present invention. Firstly, a monochromatic LCD panel 10, a single-level driver 20 and a row-modulation device 30, as those shown in the abovementioned embodiments, are prepared, wherein the monochromatic LCD panel 10 has a resolution of (A rows)*(D columns), and (B+1) gray levels are intended to generate. Thus, the single-level driver 20 should have a resolution of at least (C columns)*(A rows), wherein C is the product of A and B. In other words, the single-level driver 20 should sequentially generate C pieces of original common voltage signals 21 and A pieces of segment voltage signals. Further, in the row-modulation device 30, B pieces of input junctions 31 are assembled together and then outputs from one output junction 32.

Next, the single-level driver 20 is electrically coupled to a plurality of segment electrodes 12 via a plurality of segment circuits 40. Next, the single-level driver 20 is electrically coupled to a plurality of input junctions 31 of the row-modulation device 30 via a plurality of common circuits 50. Next, a plurality of output junctions 32 of the row-modulation device 30 are electrically coupled to a plurality of common electrodes 11 via a plurality of common-set circuits 51.

Refer to FIG. 6. In the row-modulation device 30, four pieces of input junctions 31 are assembled together and then outputs from one output junction 32. Therefore, the monochromatic pixel 13 corresponding to one common electrode 11 is driven by new common voltage signals 22 (XCOM0-XCOM3) provided by the common-set circuits 51. In other words, the monochromatic pixel 13 is driven by four original common voltage signals 21 in a time-division mode. The new common voltage signals 22 cooperate with the segment voltage signals of the segment electrodes 12 to generate voltage differences, and the voltage differences drive the monochromatic pixel 13 to generate the turn-on and turn-off states in a time-division mode. The ratio of turn-on cycles and turn-off cycles, and the vision persistence accumulates the effects of turn-on cycles and turn-off cycles of different ratios, whereby 5 different gray levels are created. It deserves to be particularly mentioned: when N pieces of input junctions 31 are assembled together and then outputs from one output junction 32, (N+1) gray levels are created.

In the present invention, the row-modulation device 30 inputs at least two sequentially generated original common voltage signals 21 to the common electrode 11 of the same row and generate new common voltage signals 22, and the new common voltage signals 22 cooperate with the segment voltage signals to turn on or turn off the monochromatic pixel 13 in a time-division mode, and the vision persistence accumulates the effects of turn-on cycles and turn-off cycles to present gray levels.

Distinct from the prior arts, the present invention adopts a row-modulation method to generate gray levels, which is an intermediate of the FRM technology and the PWM technology. The FRM technology is based on the overlap of frames, and the PWM technology is based on the time division of row interpolation. The present invention needn't use a conventional gray-level driving chip but needs only a conventional single-level driving chip to perform row-modulation and generate gray levels.

What is claimed is:

1. A row-modulation gray-level liquid crystal display device comprising
a monochromatic LCD (Liquid Crystal Display) panel having a plurality of common electrodes and a plurality of segment electrodes, wherein said common electrodes and said segment electrodes intersect vertically and are respectively arranged on an upper layer and a lower layer;
a single-level driver sequentially generating a plurality of original common voltage signals and a plurality of segment voltage signals according to a timing, and electrically coupled to said segment electrodes via a plurality of segment circuits; and
a row-modulation device having a plurality of input junctions and a plurality of output junctions, wherein said input junctions are arranged into at least two sets, and each of said sets is electrically coupled to one of said output junctions, and wherein said single-level driver is electrically coupled to said input junctions of said row-modulation device via a plurality of common circuits, and wherein said output junctions of said row-modulation device are electrically coupled to said common electrodes via a plurality of common-set circuits.

2. The row-modulation gray-level liquid crystal display device according to claim 1, wherein said monochromatic LCD panel has a plurality of monochromatic pixels corresponding to intersections of said common electrodes and said segment electrodes.

3. The row-modulation gray-level liquid crystal display device according to claim 2, wherein said monochromatic pixels are driven by voltage differences between said segment voltage signals and said original common voltage signals.

4. A row-modulation gray-level method for a liquid crystal display device comprising steps:
preparing a monochromatic LCD (Liquid Crystal Display) panel having a plurality of common electrodes and a plurality of segment electrodes, wherein said common electrodes and said segment electrodes intersect vertically and are respectively arranged on an upper layer and a lower layer;
preparing a single-level driver sequentially generating a plurality of original common voltage signals and a plurality of segment voltage signals according to a timing;
electrically coupling said single-level driver and said segment electrodes via a plurality of segment circuits;
preparing a row-modulation device having a plurality of input junctions and a plurality of output junctions, wherein said input junctions are arranged into at least two sets, and each of said sets is electrically coupled to one of said output junctions; and
electrically coupling said single-level driver and said input junctions of said row-modulation device via a plurality of common circuits; and electrically coupling said output junctions of said row-modulation device and said common electrodes via a plurality of common-set circuits.
